(19) United States
(12) Patent Application Publication
(10) Pub. No.: US 2024/0378229 A1
(43) Pub. Date: Nov. 14, 2024

(54) GENERATING REPORTS OF DATA ASSOCIATED WITH ENTITIES

(71) Applicant: SAP SE, Walldorf (DE)

(72) Inventors: Kalpana Nikhade, Pune (IN); Sri Sai Teja Gundabathula, Bangalore (IN); Vijaysing Rajput, Pune (IN)

(21) Appl. No.: 18/316,153

(22) Filed: May 11, 2023

(51) Int. Cl. G06F 16/383; G06F 16/25; G06F 16/338

(52) U.S. Cl. CPC G06F 16/383; G06F 16/25; G06F 16/33; G06F 16/338; G06F 16/38

(57) ABSTRACT

Some embodiments provide a non-transitory machine-readable medium that stores a program. The program may receive a request for a report comprising data associated with an entity. The program may, in response to the request, determine a set of sections for the report. The program may, for each section in the set of sections, generate a query for retrieving, from a storage, a set of data associated with the entity and executing the query to retrieve the set of data. The program may generate the report comprising the set of sections, wherein each section in the generated report includes a different set of data retrieved from the storage.

### BACKGROUND

Relational databases are a type of database that stores data based on relational models of data. For example, relational databases store information in tables organized according to columns and rows. Each table represents a different type of information, and the columns describe the different aspects of that information. The tables are related to each other through keys, which are unique identifiers that are used to link rows in different tables. Relational databases are organized in a way that makes it easy to search for and retrieve specific information. They are widely used in business and other applications where large amounts of data need to be stored and managed efficiently.

Non-relational databases are a type of database that stores data differently than relational databases. For instance, unlike relational databases, non-relational databases use a variety of different data models (e.g., key-value, document, graph, column-family stores). One of the advantages of non-relational databases is their ability to handle large amounts of unstructured or semi-structured data (e.g., social media posts, user-generated content, sensor data, etc.), which may not fit well into a structured table. Non-relational databases also provide greater flexibility and scalability, allowing for easy horizontal scaling and the ability to handle high traffic loads. However, non-relational databases typically sacrifice some of the consistency and data integrity guarantees provided by relational databases. They often trade strict data consistency for high availability and partition tolerance.

### SUMMARY

In some embodiments, the techniques described herein relate to a non-transitory machine-readable medium storing a program executable by at least one processing unit of a device, the program including sets of instructions for: receiving a request for a report including data associated with an entity; in response to the request, determining a set of sections for the report; for each section in the set of sections, generating a query for retrieving, from a storage, a set of data associated with the entity and executing the query to retrieve the set of data; and generating the report including the set of sections, wherein each section in the generated report includes a different set of data retrieved from the storage.

In some embodiments, the techniques described herein relate to a non-transitory machine-readable medium, wherein the storage is a first storage, wherein determining the set of sections in the report includes querying a second storage configured to store metadata associated with the entity in order to retrieve a set of section identifiers associated with the entity and determining a number of sections in the set of sections is equal to a number of unique sections identifiers in the set of section identifiers.

In some embodiments, the techniques described herein relate to a non-transitory machine-readable medium, wherein generating the report includes, for each section in the report, formatting a set of columns and storing the set of data in the set of columns.

In some embodiments, the techniques described herein relate to a non-transitory machine-readable medium, wherein the storage is a first storage, wherein generating the report further includes, for each section in the report, querying a second storage configured to store metadata associated with the entity in order to retrieve column information for the set of columns, wherein formatting the set of columns is based on the retrieved column information.

In some embodiments, the techniques described herein relate to a non-transitory machine-readable medium, wherein the storage is a first storage, wherein the program further includes sets of instructions for: storing a plurality of transactional data in a second storage configured to store transactional data in a structured manner; and transferring a subset of the plurality of transactional data from the second storage to the first storage, wherein the first storage is configured to store the subset of the plurality of transactional data in an unstructured manner.

In some embodiments, the techniques described herein relate to a non-transitory machine-readable medium, wherein the second storage is a relational database, wherein the first storage is a non-relational database.

In some embodiments, the techniques described herein relate to a non-transitory machine-readable medium, wherein the program further includes a set of instructions for receiving a set of filter values from a client device, wherein, for each section in the set of sections, generating the query for retrieving, from the storage, the set of data associated with the entity includes including the set of filter values in the query.

In some embodiments, the techniques described herein relate to a method including: receiving a request for a report including data associated with an entity; in response to the request, determining a set of sections for the report; for each section in the set of sections, generating a query for retrieving, from a storage, a set of data associated with the entity and executing the query to retrieve the set of data; and generating the report including the set of sections, wherein each section in the generated report includes a different set of data retrieved from the storage.

In some embodiments, the techniques described herein relate to a method, wherein the storage is a first storage, wherein determining the set of sections in the report includes querying a second storage configured to store metadata associated with the entity in order to retrieve a set of section identifiers associated with the entity and determining a number of sections in the set of sections is equal to a number of unique sections identifiers in the set of section identifiers.

In some embodiments, the techniques described herein relate to a method, wherein generating the report includes, for each section in the report, formatting a set of columns and storing the set of data in the set of columns.

In some embodiments, the techniques described herein relate to a method, wherein the storage is a first storage, wherein generating the report further includes, for each section in the report, querying a second storage configured to store metadata associated with the entity in order to retrieve column information for the set of columns, wherein formatting the set of columns is based on the retrieved column information.

In some embodiments, the techniques described herein relate to a method, wherein the storage is a first storage, the method further including: storing a plurality of transactional data in a second storage configured to store transactional data in a structured manner; and transferring a subset of the plurality of transactional data from the second storage to the first storage, wherein the first storage is configured to store the subset of the plurality of transactional data in an unstructured manner.

In some embodiments, the techniques described herein relate to a method, wherein the second storage is a relational database, wherein the first storage is a non-relational database.

In some embodiments, the techniques described herein relate to a method further including receiving a set of filter values from a client device, wherein, for each section in the set of sections, generating the query for retrieving, from the storage, the set of data associated with the entity includes including the set of filter values in the query.

In some embodiments, the techniques described herein relate to a system including: a set of processing units; and a non-transitory machine-readable medium storing instructions that when executed by at least one processing unit in the set of processing units cause the at least one processing unit to: receive a request for a report including data associated with an entity; in response to the request, determine a set of sections for the report; for each section in the set of sections, generate a query for retrieving, from a storage, a set of data associated with the entity and executing the query to retrieve the set of data; and generate the report including the set of sections, wherein each section in the generated report includes a different set of data retrieved from the storage.

In some embodiments, the techniques described herein relate to a system, wherein the storage is a first storage, wherein determining the set of sections in the report includes querying a second storage configured to store metadata associated with the entity in order to retrieve a set of section identifiers associated with the entity and determining a number of sections in the set of sections is equal to a number of unique sections identifiers in the set of section identifiers.

In some embodiments, the techniques described herein relate to a system, wherein generating the report includes, for each section in the report, formatting a set of columns and storing the set of data in the set of columns.

In some embodiments, the techniques described herein relate to a system, wherein the storage is a first storage, wherein generating the report further includes, for each section in the report, querying a second storage configured to store metadata associated with the entity in order to retrieve column information for the set of columns, wherein formatting the set of columns is based on the retrieved column information.

In some embodiments, the techniques described herein relate to a system, wherein the storage is a first storage, wherein the instructions further cause the at least one processing unit to: store a plurality of transactional data in a second storage configured to store transactional data in a structured manner; and transfer a subset of the plurality of transactional data from the second storage to the first storage, wherein the first storage is configured to store the subset of the plurality of transactional data in an unstructured manner.

In some embodiments, the techniques described herein relate to a system, wherein the second storage is a relational database, wherein the first storage is a non-relational database.

The following detailed description and accompanying drawings provide a better understanding of the nature and advantages of various embodiments of the present disclosure.

### BRIEF DESCRIPTION OF THE DRAWINGS

FIG. 1 illustrates a system for generating reports of data associated with entities according to some embodiments.

FIGS. 2A-2C illustrate an example report of data associated with an entity according to some embodiments.

FIG. 3 illustrates a process for generating a report of data associated with an entity according to some embodiments.

FIG. 4 illustrates an exemplary computer system, in which various embodiments may be implemented.

FIG. 5 illustrates an exemplary computing device, in which various embodiments may be implemented.

FIG. 6 illustrates an exemplary system, in which various embodiments may be implemented.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for generating reports of data associated with entities. In some embodiments, a computing system includes a relational database that stores transactional data and a non-relational database that stores archived transactional data. At defined times or defined intervals, the computing system archives some transactional data in the relational database by removing it from the relational database, converting the transactional data from a relational format to a non-relational format, and then storing the converted transactional data in the non-relational database. The computing system may receive from client devices requests for reports that include data associated with entities. In response to a request for a report that includes data associated with an entity, the computing system retrieves a report definition associated with the entity. The report definition can specify a set of columns to include in the report. Next, the computing system determines how many sections are to be included in the report. For each section to be included in the report, the computing system generates a query for values of a subset of the columns to include in the report and executes the query to retrieve the values of the subset of the columns. After all the column values have been retrieved, the computing system generates the report by creating the sections to be included in the report and populating each subset of column values in its corresponding section. The report presents the data associated with the entity, which was stored in the non-relational database, in a relational manner.

As mentioned above, transactional data is stored in a relational database of the computing system while archived transactional data is stored in the non-relational database of the computing system. When transactional data in the relational database is archived, the computing system converts the transactional data from a relational format to a non-relational format before storing it in the non-relational database. Archived data may be accessed by users in the form of reports generated by the computing system. Often users need the data in the generated reports to be in a relational format. As such, the techniques described herein leverage the metadata describing the transactional data in order to process archived transactional data so that it can be presented in a relational format.

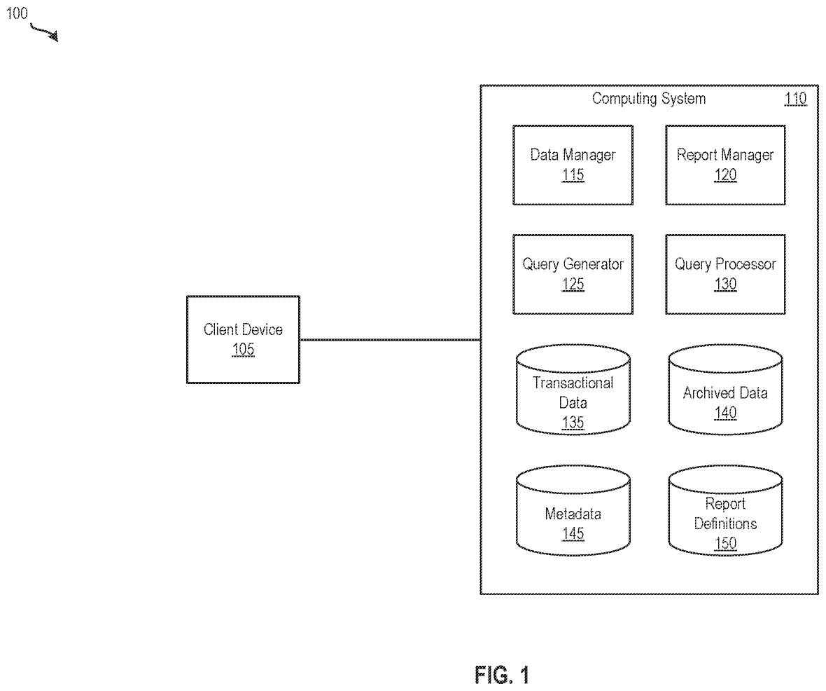

FIG. 1 illustrates a system 100 for generating reports of data associated with entities according to some embodiments. As shown, system 100 includes client device 105 and computing system 110. Client device 105 interacts and communicates with computing system 110. For example, a user of client device 105 may send computing system 110 a request for a report containing data associated with an entity. In some cases, client device 105 may receive from computing system 110 a graphical user interface (GUI) that includes several options for requesting predefined reports. Client device 105 can present the GUI to the user, which the user can use to select one of the options in order to request a particular predefined report. The user of client device 105 may provide a set of filter values along with the request for the report. Based on the request, the user of client device 105 can receive from computing system 110 the requested report or a link to download the report.

As depicted in FIG. 1, computing system 110 includes data manager 115, report manager 120, query generator 125, query processor 130, and storages 135-150. Transactional data storage 135 is configured to store transactional data (e.g., data describing transactions). In some embodiments, transactional data storage 135 includes a set of relational databases that stores data according to relational models of data. In some such embodiments, the set of relational databases store data in related tables organized in terms of rows and columns. In other embodiments, transactional data storage 135 includes a set of databases that stores data in a structured manner. Archived data storage 140 stores transactional data that has been archived. In some embodiments, archived data storage 140 includes a set of non-relational databases for storing the archived transactional data. A non-relational database may be referred to as a non-structured query language (SQL) database or a NoSQL database. Examples of types of non-relational databases include a key-value store, an object database, a document store, a wide-column store, a graph database, etc. In other embodiments, archived data storage 140 includes a set of databases that stores data in an unstructured manner. Metadata storage 145 is configured to store metadata describing the data stored in transactional data storage 135. Examples of such metadata include names of entities, sections of reports associated with entities, names of tables, column information associated with columns in tables, etc. Examples of column information include the name of a column, the type of data that can be stored in the column, the size of the column, whether the column is filterable, a mapping between the name of the column in transactional data storage 135 and the name of a corresponding field in archived data storage 140, etc. Report definitions storage 150 stores report definitions. In some embodiments, a report definition is associated with an entity, specifies a set of columns associated with the entity, and specifies, for each section in a report, a subset of the set of columns to include in the section.

Data manager 115 is responsible for managing data for transactional data storage 135 and archived data storage 140. For example, when computing system 110 receives (e.g., from other computing devices) or generates transactional data, data manager 115 stores the transactional data in transactional data storage 135. At defined times (e.g., every Monday and Friday, every 15th of the month, etc.) or at defined intervals (e.g., once a day, once a week, once a month, once a quarter, etc.), data manager 115 may archive some of the data stored in transactional data storage 135 into archived data storage 140. In some embodiments, data manager 115 determines the data to be archived by identifying data stored in transactional data storage 135 that falls outside a defined window of time (e.g., the most recent six months, the most recent year, the most recent two years, etc.). To archive data stored in transactional data storage 135, data manager 115 removes the identified transactional data from transactional data storage 135, converts the transactional data from a relational format to a non-relational format, and stores the converted transactional data in archived data storage 140.

Report manager 120 handles the management of reports of data associated with entities. For instance, report manager 120 can provide client device 105 a GUI that includes several options for requesting predefined reports. For each option for a predefined report, report manager 120 may also include options for specifying filter values to apply to the report. Report manager 120 can receive from client device 105, via the GUI, a request for a predefined report and, optionally, a set of filter values to apply to the report. Upon receiving a request for a report from client device 105, report manager 120 accesses report definitions storage 150 to retrieve the report definition associated with the entity. Next, report manager 120 determines the number of sections to include in the report. In some embodiments, report manager 120 makes such a determination by accessing metadata storage 145 to retrieve unique section identifiers (IDs) associated with the entity and determining that the number of sections to include in the report is equal to the number of unique section IDs associated with the entity. Then, report manager 120 sends query generator 125 the report definition and a request to generate queries for the report. In return, report manager 120 receives query results from query processor 130. The query results include values for the set of columns associated with the entity specified in the report definition. Report manager 120 iterates through the query results and determines if they contain any arrays of data. When report manager 120 identifies an array of data, report manager 120 extracts each piece of data out from the array. In this manner, report manager 120 flattens the data in the query results.

Once report manager 120 has processed the query results, report manager 120 then generates a report that includes the determined sections. For each section, report manager 120 accesses metadata storage 145 to retrieve the column information associated with the columns specified for the section. Next, report manager 120 generates columns in the section and formats the columns according to the column information. This way, the columns in the sections are configured with the same characteristics (e.g., the name of the column, the type of data that can be stored in the column, the size of the column, etc.) as the corresponding columns in transactional data storage 135. Report manager 120 populates the columns of the section with the corresponding column values in the set of column values. Finally, report manager 120 sends the generated report to client device 105. In some embodiments, the generated report is a spreadsheet file and each section in the report is a separate sheet in the spreadsheet file. In some cases, report manager 120 provides client device 105 with a link (e.g., a uniform resource locator (URL) link) to the generated report that can be used to download the report.

Query generator 125 is configured to generate queries for reports of data associated with entities. For instance, query generator 125 can receive from report manager 120 a report definition and a request to generate queries for a report. In response to the request, query generator 125 generates a query for each section of the report. In some embodiments, query generator 125 generates a query for a section of a report by iterating through each column specified for the section in the report definition and determining whether the column is filterable. Query generator 125 can determine whether a column is filterable by accessing metadata storage 145 to check whether the column information associated with the column specifies that the column is filterable. If so, query generator 125 generates a WHERE clause and applies to the column any filter values specified for the column. Otherwise, query generator 125 determines whether the column belongs to a one-to-many relation with another entity. If so, query generator 125 generates a set of join conditions between the column associated with the entity and the other entity. Next, query generator 125 maps the name of the column, which is the name of the column in transactional data storage 135, to the name of the field in archived data storage 140 based on the metadata stored in metadata storage 145 and then generates a SELECT clause using the name of the field. If query generator 125 determines that the column does not belong to a one-to-many relation with another entity, query generator 125 skips the generation of join conditions and just maps the name of the column to the name of the field in archived data storage 140 based on the metadata stored in metadata storage 145 and generates a SELECT clause using the name of the field. After iterating through all the columns, query generator 125 generates the query by combining all the generated clauses together. Once a query has been generated for each section in the report, query generator 125 sends the queries to query processor 130 for processing.

Query processor 130 is responsible for processing queries received from query generator 125. For example, when query processor 130 receives a query from query generator 125, query processor 130 accesses archived data storage 140 to execute the query for data stored in archived data storage 140. In some embodiments, query processor 130 receives the results of the query in a JavaScript Object Notation (JSON) format. Query processor 130 sends the query results to report manager 120.

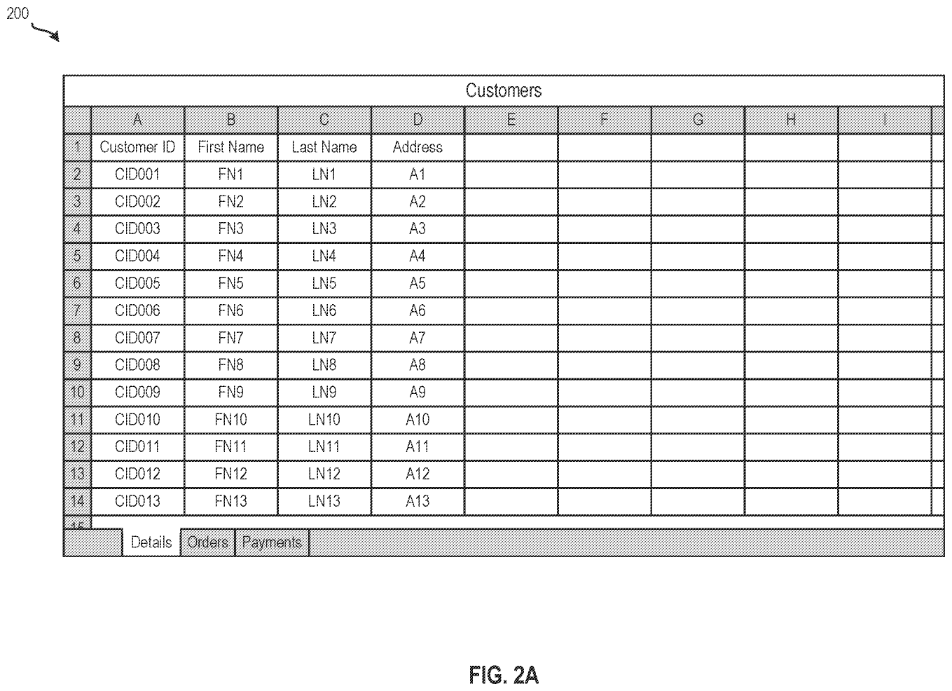

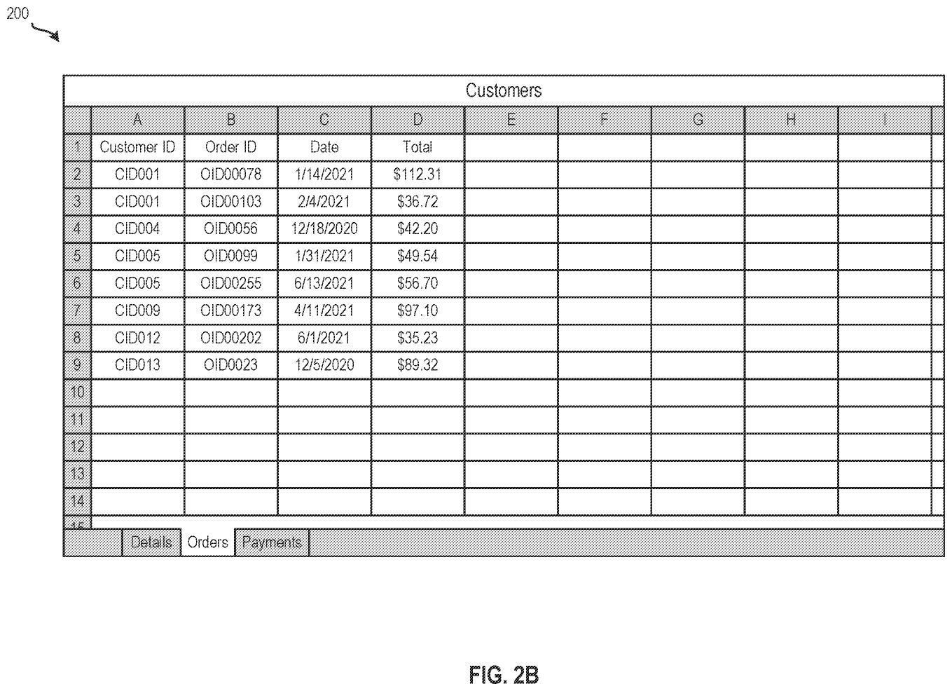

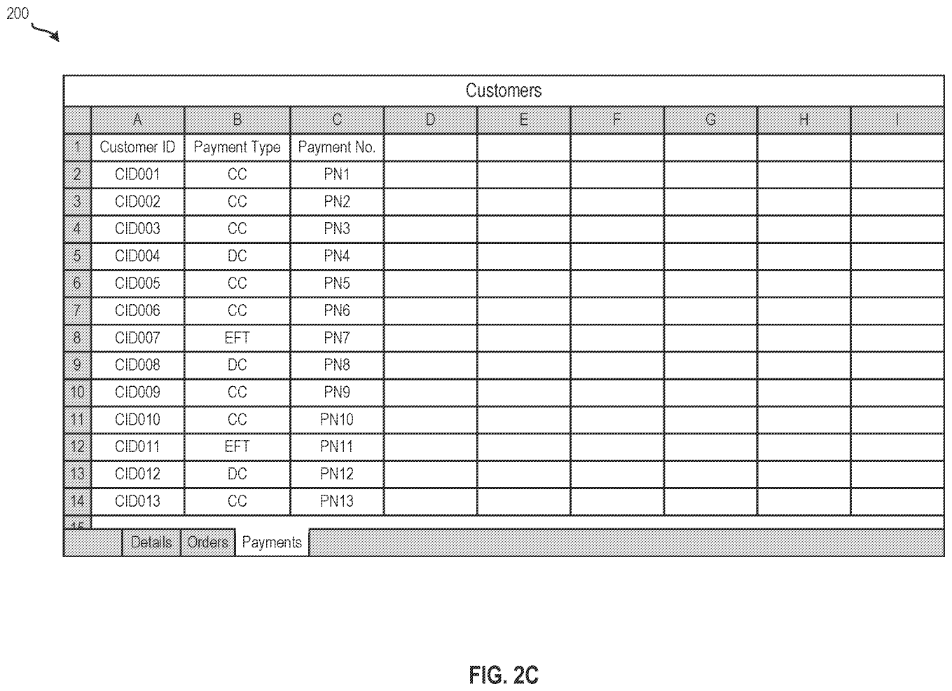

An example operation of system 100 will now be described by reference to FIGS. 2A-2C. The example will demonstrate how a report of data associated with an entity is generated. FIGS. 2A-2C illustrate an example report 200 of data associated with an entity according to some embodiments. For this example, report 200 is a spreadsheet file. FIG. 2A illustrates report 200 of data associated with an entity. Specifically, report 200 includes data associated with a customer entity. The example operation begins with report manager 120 providing client device 105 a GUI that includes several options for requesting predefined reports. A user of client device 105 sends report manager 120 a request for a report of data associated with the customer entity by selecting the option corresponding to the predefined report for the customer entity.

In response to the request, report manager 120 accesses report definitions storage 150 to retrieve the report definition associated with the customer entity. Here, the report definition specifies a set of columns associated with the entity, a first subset of the set of columns for a “Details” section, a second subset of the set of columns for a “Orders” section, and a third subset of the set of columns for a “Payments” section. The first subset of the set of columns specifies a Customer ID column, a First Name column, a Last Name column, and an Address column. The second subset of the set of columns specifies a Customer ID column, an Order ID column, a Date column, and a Total column. The third subset of the set of columns specifies a Customer ID column, a Payment Type column, and a Payment Number column.

Report manager 120 then determines the number of sections to include in the report by accessing metadata storage 145 to retrieve unique section IDs associated with the customer entity and determining that the number of sections to include in the report is equal to the number of unique section IDs associated with the customer entity. In this example, report manager 120 retrieves from metadata storage 145 three unique section IDs associated with the customer entity: a first section ID for a “Details” section, a second section ID for an “Orders” section, and a third section ID for a “Payments” section. Next, report manager 120 sends query generator 125 the report definition for the customer entity and a request to generate queries for the report.

When query generator 125 receives the report definition and the request from report manager 120, query generator 125 generates a query for each section of the report. For this example, query generator 125 generates a query for each section of the report by iterating through each column specified for the section in the report definition and determining whether the column is filterable. Query generator 125 determines whether the column is filterable by accessing metadata storage 145 to check whether the column information associated with the column specifies that the column is filterable. If so, query generator 125 generates a WHERE clause and applies any filter values associated with the column to the column. If not, query generator 125 determines whether the column belongs to a one-to-many relation with another entity. Referring to FIG. 2B as an example, the Order ID column belongs to a one-to-many relationship with the customer entity (e.g., a customer can have one or more orders). If the column has such a relationship with another entity, query generator 125 generates a set of join conditions based on the common key between with the entity and the other entity. For this example, the common key between the customer entity and the order entity is the customer ID. So, in this example, query generator 125 generates a set of join conditions between the customer ID attribute of the customer entity and the customer ID attribute of the order entity. Query generator 125 then maps the name of the column, which is the name of the column in transactional data storage 135, to the name of the field in archived data storage 140 based on the metadata stored in metadata storage 145 and generates a SELECT clause using the name of the field. If the column does not have a one-to-many relation with another entity, query generator 125 skips the generation of join conditions and, instead, maps the name of the column to the name of the field in archived data storage 140 based on the metadata stored in metadata storage 145 and generates a SELECT clause using the name of the field. Once query generator 125 has iterated through all the columns specified for the section, query generator 125 generates the query by combining all the generated clauses together. After the query has been generated for each section in the report, query generator 125 sends the queries to query processor 130 for processing.

Upon receiving the queries from query generator 125, query processor 130 executes the queries. For each query, query processor 130 accesses archived data storage 140 to execute the query for data stored in archived data storage 140 and receives the results of the query in a JSON format. The query results include values for the set of columns associated with the customer entity that are specified in the report definition. Query processor 130 sends each of the query results to report manager 120. When report manager 120 receives the query results, report manager 120 iterates through the query results and determines if they contain any arrays of data. When report manager 120 identifies an array of data, report manager 120 extracts each piece of data out from the array.

Next, report manager 120 generates a report that includes the three determined sections. For each section, report manager 120 accesses metadata storage 145 to retrieve the column information associated with the columns specified for the section. Report manager 120 then generates columns in the section and formats the columns according to the column information. Then, report manager 120 populates the columns of the section with the corresponding column values in the set of column values. After generating report 200, report manager 120 sends the generated report to client device 105.

FIG. 2A illustrates the first section of the report in this example. The first section of report 200 depicted in FIG. 2A is a “Details” section stored in a first sheet of the spreadsheet file. The first section includes data associated with customers. As shown, the “Details” section of report 200 includes a Customer ID column, a First Name column, a Last Name column, and an Address column. Here, the column information associated with the Customer ID column, the First Name column, the Last Name column, and the Address column specify a string data type. Thus, report manager 120 formats the columns in the “Details” sheet to store string data.

FIG. 2B illustrates the second section of report 200. The second section of report 200 shown in FIG. 2B is an “Orders” section stored in a second sheet of the spreadsheet file. The second section includes data associated with orders of customers. The “Orders” section of report 200 includes a Customer ID column, an Order ID column, a Date column, and a Total column. For this example, the column information associated with the Customer ID column and the Order ID column specify a string data type, the column information associated with the Date column specifies a date data type, and the column information associated with the Total column specifies a currency data type. Therefore, report manager 120 formats the Customer ID and Order ID columns to store string data; formats the Date column to store date data, and formats the Total column to store currency data.

FIG. 2C illustrates the third section of report 200 in this example. The third section of report 200 is a “Payments” section stored in a third sheet of the spreadsheet file. The third section includes data associated with forms of payment of customers. The “Payments” section of report 200 includes a Customer ID column, a Payment Type column, and a Payment Number column. In this example, the column information associated with the Customer ID column, the Payment Type column, and the Payment Number column specify a string data type. As such, report manager 120 formats these columns to store string data.

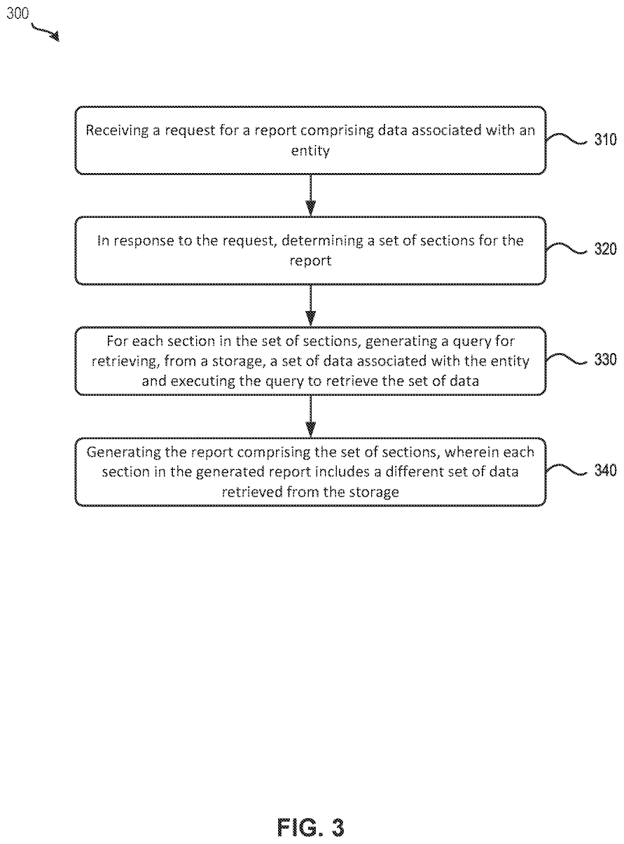

FIG. 3 illustrates a process 300 for generating a report of data associated with an entity according to some embodiments. In some embodiments, computing system 110 performs process 300. Process 300 starts by receiving, at 310, a request for a report comprising data associated with an entity. Referring to FIG. 1 as an example, computing system 110 can receive the request for the report comprising data associated with the entity from client device 105.

In response to the request, process 300 determines, at 320, a set of sections for the report. Referring to FIG. 1 as an example, report manager 120 may determine the number of sections to include in the report by accessing metadata storage 145 to retrieve unique section IDs associated with the entity and determine that the number of sections to include in the report is equal to the number of unique section IDs associated with the entity.

For each section in the set of sections, process 300 generates, at 330, a query for retrieving, from a storage, a set of data associated with the entity and executing the query to retrieve the set of data. Referring to FIG. 1 as an example, query generator 125 can, for each section in the set of sections, generate a query for retrieving, from archived data storage 140, a set of data associated with the entity. Query processor 130 may execute these queries.

Finally, process 300 generates, at 340, the report comprising the set of sections, wherein each section in the generated report includes a different set of data retrieved from the storage. Referring to FIGS. 1 and 2A-2C as an example, report manager 120 may generate report 200, which includes three sections. Each section in report 200 includes a different set of data retrieved from archived data storage 140.

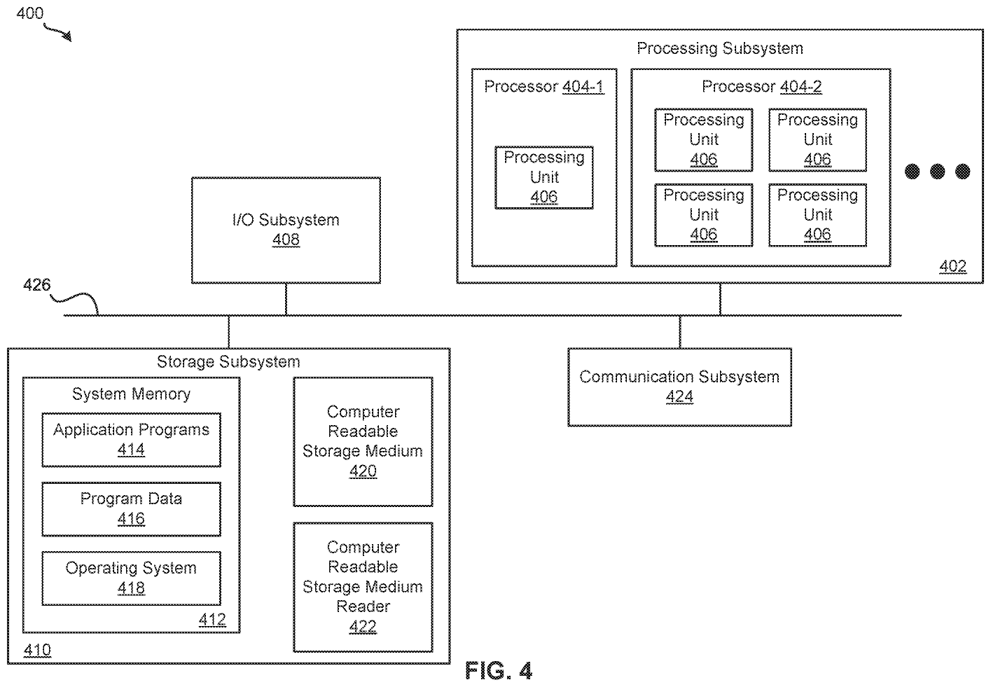

FIG. 4 illustrates an exemplary computer system 400 for implementing various embodiments described above. For example, computer system 400 may be used to implement client device 105 and computing system 110. Computer system 400 may be a desktop computer, a laptop, a server computer, or any other type of computer system or combination thereof. Some or all elements of data manager 115, report manager 120, query generator 125, query processor 130, or combinations thereof can be included or implemented in computer system 400. In addition, computer system 400 can implement many of the operations, methods, and/or processes described above (e.g., process 300). As shown in FIG. 4, computer system 400 includes processing subsystem 402, which communicates, via bus subsystem 426, with input/output (I/O) subsystem 408, storage subsystem 410 and communication subsystem 424.

Bus subsystem 426 is configured to facilitate communication among the various components and subsystems of computer system 400. While bus subsystem 426 is illustrated in FIG. 4 as a single bus, one of ordinary skill in the art will understand that bus subsystem 426 may be implemented as multiple buses. Bus subsystem 426 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 402, which can be implemented as one or more integrated circuits (e.g., a conventional microprocessor or microcontroller), controls the operation of computer system 400. Processing subsystem 402 may include one or more processors 404. Each processor 404 may include one processing unit 406 (e.g., a single core processor such as processor 404-1) or several processing units 406 (e.g., a multicore processor such as processor 404-2). In some embodiments, processors 404 of processing subsystem 402 may be implemented as independent processors while, in other embodiments, processors 404 of processing subsystem 402 may be implemented as multiple processors integrate into a single chip or multiple chips. Still, in some embodiments, processors 404 of processing subsystem 402 may be implemented as a combination of independent processors and multiple processors integrated into a single chip or multiple chips.

In some embodiments, processing subsystem 402 can execute a variety of programs or processes in response to program code and can maintain multiple concurrently executing programs or processes. At any given time, some or all of the program code to be executed can reside in processing subsystem 402 and/or in storage subsystem 410. Through suitable programming, processing subsystem 402 can provide various functionalities, such as the functionalities described above by reference to process 300.

I/O subsystem 408 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 400 to a user or another device (e.g., a printer).

As illustrated in FIG. 4, storage subsystem 410 includes system memory 412, computer-readable storage medium 420, and computer-readable storage medium reader 422. System memory 412 may be configured to store software in the form of program instructions that are loadable and executable by processing subsystem 402 as well as data generated during the execution of program instructions. In some embodiments, system memory 412 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 412 may include different types of memory, such as static random access memory (SRAM) and/or dynamic random access memory (DRAM). System memory 412 may include a basic input/output system (BIOS), in some embodiments, that is configured to store basic routines to facilitate transferring information between elements within computer system 400 (e.g., during start-up). Such a BIOS may be stored in ROM (e.g., a ROM chip), flash memory, or any other type of memory that may be configured to store the BIOS.

As shown in FIG. 4, system memory 412 includes application programs 414, program data 416, and operating system (OS) 418. OS 418 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple IOS, Windows Phone, Windows Mobile, Android, BlackBerry OS, Blackberry 10, and Palm OS, WebOS operating systems.

Computer-readable storage medium 420 may be a non-transitory computer-readable medium configured to store software (e.g., programs, code modules, data constructs, instructions, etc.). Many of the components (e.g., data manager 115, report manager 120, query generator 125, and query processor 130) and/or processes (e.g., process 300) described above may be implemented as software that when executed by a processor or processing unit (e.g., a processor or processing unit of processing subsystem 402) performs the operations of such components and/or processes. Storage subsystem 410 may also store data used for, or generated during, the execution of the software.

Storage subsystem 410 may also include computer-readable storage medium reader 422 that is configured to communicate with computer-readable storage medium 420. Together and, optionally, in combination with system memory 412, computer-readable storage medium 420 may comprehensively represent remote, local, fixed, and/or removable storage devices plus storage media for temporarily and/or more permanently containing, storing, transmitting, and retrieving computer-readable information.

Computer-readable storage medium 420 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 424 serves as an interface for receiving data from, and transmitting data to, other devices, computer systems, and networks. For example, communication subsystem 424 may allow computer system 400 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 424 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 424 may provide components configured for wired communication (e.g., Ethernet) in addition to or instead of components configured for wireless communication.

One of ordinary skill in the art will realize that the architecture shown in FIG. 4 is only an example architecture of computer system 400, and that computer system 400 may have additional or fewer components than shown, or a different configuration of components. The various components shown in FIG. 4 may be implemented in hardware, software, firmware or any combination thereof, including one or more signal processing and/or application specific integrated circuits.

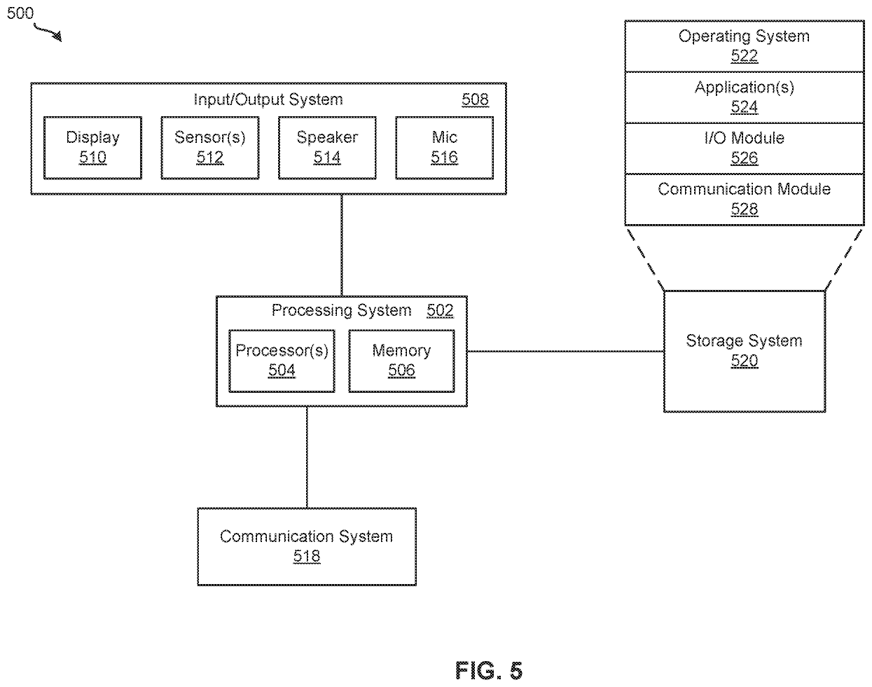

FIG. 5 illustrates an exemplary computing device 500 for implementing various embodiments described above. For example, computing device 500 may be used to implement client device 105. Computing device 500 may be a cellphone, a smartphone, a wearable device, an activity tracker or manager, a tablet, a personal digital assistant (PDA), a media player, or any other type of mobile computing device or combination thereof. As shown in FIG. 5, computing device 500 includes processing system 502, input/output (I/O) system 508, communication system 518, and storage system 520. These components may be coupled by one or more communication buses or signal lines.

Processing system 502, which can be implemented as one or more integrated circuits (e.g., a conventional microprocessor or microcontroller), controls the operation of computing device 500. As shown, processing system 502 includes one or more processors 504 and memory 506. Processors 504 are configured to run or execute various software and/or sets of instructions stored in memory 506 to perform various functions for computing device 500 and to process data.

Each processor of processors 504 may include one processing unit (e.g., a single core processor) or several processing units (e.g., a multicore processor). In some embodiments, processors 504 of processing system 502 may be implemented as independent processors while, in other embodiments, processors 504 of processing system 502 may be implemented as multiple processors integrated into a single chip. Still, in some embodiments, processors 504 of processing system 502 may be implemented as a combination of independent processors and multiple processors integrated into a single chip.

Memory 506 may be configured to receive and store software (e.g., operating system 522, applications 524, I/O module 526, communication module 528, etc. from storage system 520) in the form of program instructions that are loadable and executable by processors 504 as well as data generated during the execution of program instructions. In some embodiments, memory 506 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 508 is responsible for receiving input through various components and providing output through various components. As shown for this example, I/O system 508 includes display 510, one or more sensors 512, speaker 514, and microphone 516. Display 510 is configured to output visual information (e.g., a graphical user interface (GUI) generated and/or rendered by processors 504). In some embodiments, display 510 is a touch screen that is configured to also receive touch-based input. Display 510 may be implemented using liquid crystal display (LCD) technology, light-emitting diode (LED) technology, organic LED (OLED) technology, organic electro luminescence (OEL) technology, or any other type of display technologies. Sensors 512 may include any number of different types of sensors for measuring a physical quantity (e.g., temperature, force, pressure, acceleration, orientation, light, radiation, etc.). Speaker 514 is configured to output audio information and microphone 516 is configured to receive audio input. One of ordinary skill in the art will appreciate that I/O system 508 may include any number of additional, fewer, and/or different components. For instance, I/O system 508 may include a keypad or keyboard for receiving input, a port for transmitting data, receiving data and/or power, and/or communicating with another device or component, an image capture component for capturing photos and/or videos, etc.

Communication system 518 serves as an interface for receiving data from, and transmitting data to, other devices, computer systems, and networks. For example, communication system 518 may allow computing device 500 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 518 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 518 may provide components configured for wired communication (e.g., Ethernet) in addition to or instead of components configured for wireless communication.

Storage system 520 handles the storage and management of data for computing device 500. Storage system 520 may be implemented by one or more non-transitory machine-readable mediums that are configured to store software (e.g., programs, code modules, data constructs, instructions, etc.) and store data used for, or generated during, the execution of the software.

In this example, storage system 520 includes operating system 522, one or more applications 524, I/O module 526, and communication module 528. Operating system 522 includes various procedures, sets of instructions, software components and/or drivers for controlling and managing general system tasks (e.g., memory management, storage device control, power management, etc.) and facilitates communication between various hardware and software components. Operating system 522 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple IOS, Windows Phone, Windows Mobile, Android, BlackBerry OS, Blackberry 10, and Palm OS, WebOS operating systems.

Applications 524 can include any number of different applications installed on computing device 500. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 526 manages information received via input components (e.g., display 510, sensors 512, and microphone 516) and information to be outputted via output components (e.g., display 510 and speaker 514). Communication module 528 facilitates communication with other devices via communication system 518 and includes various software components for handling data received from communication system 518.

One of ordinary skill in the art will realize that the architecture shown in FIG. 5 is only an example architecture of computing device 500, and that computing device 500 may have additional or fewer components than shown, or a different configuration of components. The various components shown in FIG. 5 may be implemented in hardware, software, firmware or any combination thereof, including one or more signal processing and/or application specific integrated circuits.

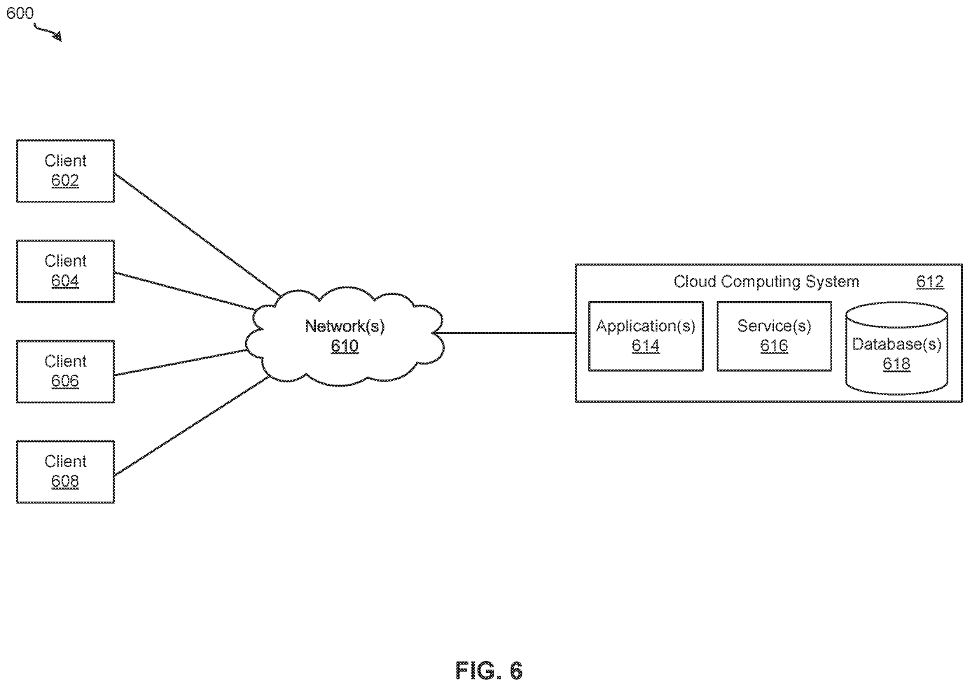

FIG. 6 illustrates an exemplary system 600 for implementing various embodiments described above. For example, any of the client devices 602-608 may be used to implement client device 105 and cloud computing system 612 may be used to implement computing system 110. As shown, system 600 includes client devices 602-608, one or more networks 610, and cloud computing system 612. Cloud computing system 612 is configured to provide resources and data to client devices 602-608 via networks 610. In some embodiments, cloud computing system 612 provides resources to any number of different users (e.g., customers, tenants, organizations, etc.). Cloud computing system 612 may be implemented by one or more computer systems (e.g., servers), virtual machines operating on a computer system, or a combination thereof.

As shown, cloud computing system 612 includes one or more applications 614, one or more services 616, and one or more databases 618. Cloud computing system 612 may provide applications 614, services 616, and databases 618 to any number of different customers in a self-service, subscription-based, elastically scalable, reliable, highly available, and secure manner.

In some embodiments, cloud computing system 612 may be adapted to automatically provision, manage, and track a customer's subscriptions to services offered by cloud computing system 612. Cloud computing system 612 may provide cloud services via different deployment models. For example, cloud services may be provided under a public cloud model in which cloud computing system 612 is owned by an organization selling cloud services and the cloud services are made available to the general public or different industry enterprises. As another example, cloud services may be provided under a private cloud model in which cloud computing system 612 is operated solely for a single organization and may provide cloud services for one or more entities within the organization. The cloud services may also be provided under a community cloud model in which cloud computing system 612 and the cloud services provided by cloud computing system 612 are shared by several organizations in a related community. The cloud services may also be provided under a hybrid cloud model, which is a combination of two or more of the aforementioned different models.

In some instances, any one of applications 614, services 616, and databases 618 made available to client devices 602-608 via networks 610 from cloud computing system 612 is referred to as a “cloud service.” Typically, servers and systems that make up cloud computing system 612 are different from the on-premises servers and systems of a customer. For example, cloud computing system 612 may host an application and a user of one of client devices 602-608 may order and use the application via networks 610.

Applications 614 may include software applications that are configured to execute on cloud computing system 612 (e.g., a computer system or a virtual machine operating on a computer system) and be accessed, controlled, managed, etc. via client devices 602-608. In some embodiments, applications 614 may include server applications and/or mid-tier applications (e.g., HTTP (hypertext transfer protocol) server applications, FTP (file transfer protocol) server applications, CGI (common gateway interface) server applications, JAVA server applications, etc.). Services 616 are software components, modules, application, etc. that are configured to execute on cloud computing system 612 and provide functionalities to client devices 602-608 via networks 610. Services 616 may be web-based services or on-demand cloud services.

Databases 618 are configured to store and/or manage data that is accessed by applications 614, services 616, and/or client devices 602-608. For instance, storages 135-150 may be stored in databases 618. Databases 618 may reside on a non-transitory storage medium local to (and/or resident in) cloud computing system 612, in a storage-area network (SAN), on a non-transitory storage medium local located remotely from cloud computing system 612. In some embodiments, databases 618 may include relational databases that are managed by a relational database management system (RDBMS). Databases 618 may be a column-oriented databases, row-oriented databases, or a combination thereof. In some embodiments, some or all of databases 618 are in-memory databases. That is, in some such embodiments, data for databases 618 are stored and managed in memory (e.g., random access memory (RAM)).

Client devices 602-608 are configured to execute and operate a client application (e.g., a web browser, a proprietary client application, etc.) that communicates with applications 614, services 616, and/or databases 618 via networks 610. This way, client devices 602-608 may access the various functionalities provided by applications 614, services 616, and databases 618 while applications 614, services 616, and databases 618 are operating (e.g., hosted) on cloud computing system 612. Client devices 602-608 may be computer system 400 or computing device 500, as described above by reference to FIGS. 4 and 5, respectively. Although system 600 is shown with four client devices, any number of client devices may be supported.

Networks 610 may be any type of network configured to facilitate data communications among client devices 602-608 and cloud computing system 612 using any of a variety of network protocols. Networks 610 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

1. A non-transitory machine-readable medium storing a program executable by at least one processing unit of a device, the program comprising sets of instructions for:
transmitting a graphical user interface that includes options for requesting a plurality of reports;
receiving a request for a report comprising data associated with an entity, the report from the plurality of reports;
in response to the request, determining a set of sections for the report;
for each section in the set of sections, generating a query for retrieving, from a first storage, a set of data associated with the entity and executing the query to retrieve the set of data;
generating the report comprising the set of sections, wherein each section in the generated report includes a different set of data retrieved from the storage;
storing a plurality of transactional data in a second storage configured to store transactional data in a structured manner;
transferring a subset of the plurality of transactional data from the second storage to the first storage; and
removing the subset of the plurality of transactional data from the first storage,
wherein the first storage is configured to store the subset of the plurality of transactional data in an unstructured manner.

2. The non-transitory machine-readable medium of claim 1, wherein determining the set of sections in the report comprises querying a second storage configured to store metadata associated with the entity in order to retrieve a set of section identifiers associated with the entity and determining a number of sections in the set of sections is equal to a number of unique sections identifiers in the set of section identifiers.

3. The non-transitory machine-readable medium of claim 1, wherein generating the report comprises, for each section in the report, formatting a set of columns and storing the set of data in the set of columns.

4. The non-transitory machine-readable medium of claim 3, wherein generating the report further comprises, for each section in the report, querying a second storage configured to store metadata associated with the entity in order to retrieve column information for the set of columns, wherein formatting the set of columns is based on the retrieved column information.

5. (canceled)

6. The non-transitory machine-readable medium of claim 1, wherein the second storage is a relational database and the first storage is a non-relational database.

7. The non-transitory machine-readable medium of claim 1, wherein the program further comprises a set of instructions for receiving a set of filter values from a client device, wherein, for each section in the set of sections, generating the query for retrieving, from the storage, the set of data associated with the entity comprises including the set of filter values in the query.

8. A method comprising:
transmitting a graphical user interface that includes options for requesting a plurality of reports;
receiving a request for a report comprising data associated with an entity, the report from the plurality of reports;
in response to the request, determining a set of sections for the report;
for each section in the set of sections, generating a query for retrieving, from a first storage, a set of data associated with the entity and executing the query to retrieve the set of data;
generating the report comprising the set of sections, wherein each section in the generated report includes a different set of data retrieved from the storage;
storing a plurality of transactional data in a second storage configured to store transactional data in a structured manner;
transferring a subset of the plurality of transactional data from the second storage to the first storage; and
removing the subset of the plurality of transactional data from the first storage,
wherein the first storage is configured to store the subset of the plurality of transactional data in an unstructured manner.

9. The method of claim 8, wherein determining the set of sections in the report comprises querying a second storage configured to store metadata associated with the entity in order to retrieve a set of section identifiers associated with the entity and determining a number of sections in the set of sections is equal to a number of unique sections identifiers in the set of section identifiers.

10. The method of claim 8, wherein generating the report comprises, for each section in the report, formatting a set of columns and storing the set of data in the set of columns.

11. The method of claim 10, wherein generating the report further comprises, for each section in the report, querying a second storage configured to store metadata associated with the entity in order to retrieve column information for the set of columns, wherein formatting the set of columns is based on the retrieved column information.

12. (canceled)

13. The method of claim 8, wherein the second storage is a relational database and the first storage is a non-relational database.

14. The method of claim 8 further comprising receiving a set of filter values from a client device, wherein, for each section in the set of sections, generating the query for retrieving, from the storage, the set of data associated with the entity comprises including the set of filter values in the query.

15. A system comprising:
a set of processing units; and
a non-transitory machine-readable medium storing instructions that when executed by at least one processing unit in the set of processing units cause the at least one processing unit to: receive a request for a report comprising data associated with an entity;
transmitting a graphical user interface that includes options for requesting a plurality of reports;
receiving a request for a report comprising data associated with an entity, the report from the plurality of reports;
in response to the request, determining a set of sections for the report;
for each section in the set of sections, generating a query for retrieving, from a first storage, a set of data associated with the entity and executing the query to retrieve the set of data;
generating the report comprising the set of sections, wherein each section in the generated report includes a different set of data retrieved from the storage;
storing a plurality of transactional data in a second storage configured to store transactional data in a structured manner;
transferring a subset of the plurality of transactional data from the second storage to the first storage; and
removing the subset of the plurality of transactional data from the first storage,
wherein the first storage is configured to store the subset of the plurality of transactional data in an unstructured manner.

16. The system of claim 15, wherein determining the set of sections in the report comprises querying a second storage configured to store metadata associated with the entity in order to retrieve a set of section identifiers associated with the entity and determining a number of sections in the set of sections is equal to a number of unique sections identifiers in the set of section identifiers.

17. The system of claim 15, wherein generating the report comprises, for each section in the report, formatting a set of columns and storing the set of data in the set of columns.

18. The system of claim 17, wherein generating the report further comprises, for each section in the report, querying a second storage configured to store metadata associated with the entity in order to retrieve column information for the set of columns, wherein formatting the set of columns is based on the retrieved column information.

19. (canceled)

20. The system of claim 15, wherein the second storage is a relational database and the first storage is a non-relational database.

21. The system of claim 15 further comprising receiving a set of filter values from a client device, wherein, for each section in the set of sections, generating the query for retrieving, from the storage, the set of data associated with the entity comprises including the set of filter values in the query.
